(19) United States
(12) Patent Application Publication
(10) Pub. No.: US 2023/0185632 A1
(43) Pub. Date: Jun. 15, 2023

(54) MANAGEMENT SYSTEM, DATA REBALANCING MANAGEMENT METHOD, AND RECORDING MEDIUM

(71) Applicant: Hitachi, Ltd., Tokyo (JP)

(72) Inventors: Hanako IWASAKI, Tokyo (JP); Toshihiro HORIE, Tokyo (JP)

(21) Appl. No.: 17/902,766

(22) Filed: Sep. 2, 2022

(30) Foreign Application Priority Data
Dec. 13, 2021 (JP) 2021-202067

(51) Int. Cl. G06F 9/50

(52) U.S. Cl. CPC G06F 9/5083

(57) ABSTRACT

A management system for managing data rebalancing in a storage system that has a plurality of nodes configured to control input and output of data for a storage device that is a control target, and redundantly stores and manages predetermined data units in a plurality of storage devices includes a processor unit. The processor unit is configured to acquire load information about paths for transmitting data of the plurality of nodes, to determine, as a transmission source of a predetermined rebalancing target data unit, all nodes for which loads of the paths for transmitting the data of the nodes are equal to or smaller than a predetermined threshold value among a plurality of nodes controlling a storage device storing the rebalancing target data unit as a control target, and to transmit different parts of the rebalancing target data unit in parallel from the plurality of nodes to a predetermined transfer destination node when a plurality of nodes are determined as the transmission source of the predetermined rebalancing target data unit.

### CROSS-REFERENCE TO PRIOR APPLICATION

This application relates to and claims the benefit of priority from Japanese Patent Application No. 2021-202067 filed on Dec. 13, 2021, the entire disclosure of which is incorporated herein by reference.

### BACKGROUND

The present disclosure relates to data rebalancing technology in a storage system composed of a plurality of nodes.

An HCl (hyper-converged infrastructure) system is known in which storage devices mounted in a plurality of servers are integrated by a software function and virtual storage is configured on the servers.

In the HCl system, data rebalancing process is executed when an I/O load of each node becomes uneven or when a node or a storage device is added or replaced.

According to rebalancing process, data of a storage device with a high usage rate migrates to a storage device with a low usage rate.

As related technology, for example, WO 2018/109816 discloses technology for determining the content of instructions including a definition regarding logical capacity allocation to an entity having a rebalancing function on the basis of capacity information including information representing a plurality of physical capacities corresponding to a plurality of storage devices including at least one storage device that is coupled to one or more computers included in a computer system and has a compression function.

### SUMMARY

For example, during rebalancing process, the I/O performance of each node deteriorates, which affects the performance of a system in operation on each node. In order to avoid the influence of such rebalancing process on the performance of the system in operation, rebalancing process is often manually executed by a user when the system is stopped at night or on holidays, and thus the operational load on the user is increased.

The present disclosure has been made in view of the aforementioned circumstances, and an object thereof is to provide a technology capable of appropriately rebalancing data.

To accomplish the aforementioned object, a management system according to one aspect is a management system for managing data rebalancing in a storage system that has a plurality of nodes configured to control input and output of data for a storage device that is a control target, and redundantly stores and manages predetermined data units in a plurality of storage devices, the management system includes a processor unit, and the processor unit is configured to acquire load information about paths for transmitting data of the plurality of nodes, to determine, as a transmission source of a predetermined rebalancing target data unit, all nodes for which loads of the paths for transmitting the data of the nodes are equal to or smaller than a predetermined threshold value among a plurality of nodes controlling a storage device storing the rebalancing target data unit as a control target, and to transmit different parts of the rebalancing target data unit in parallel from the plurality of nodes to a predetermined transfer destination node when a plurality of nodes are determined as the transmission source of the predetermined rebalancing target data unit.

### BRIEF DESCRIPTION OF THE DRAWINGS

FIG. 1 is an overall configuration diagram of a computer system according to an embodiment;

FIG. 2 is a configuration diagram of a computer according to an embodiment;

FIG. 3 is a configuration diagram of a management system according to an embodiment;

FIG. 4 is a configuration diagram of a backup system according to an embodiment;

FIG. 5 is a configuration diagram of a virtualization environment management system according to an embodiment;

FIG. 6 is a configuration diagram of a container environment management system according to an embodiment;

FIG. 7 is a configuration diagram of a user configuration table according to an embodiment;

FIG. 8 is a configuration diagram of a rebalancing path table according to an embodiment;

FIG. 9 is a configuration diagram of a node information table according to an embodiment;

FIG. 10 is a configuration diagram of a volume information table according to an embodiment;

FIG. 11 is a configuration diagram of a communication path information table according to an embodiment;

FIG. 12 is a configuration diagram of a backup information table according to an embodiment;

FIG. 13 is a configuration diagram of a virtualization environment information table according to an embodiment;

FIG. 14 is a configuration diagram of a container environment information table according to an embodiment;

FIG. 15 is a configuration diagram of a rebalancing time management table according to an embodiment;

FIG. 16 is a flowchart of rebalancing preparation process according to an embodiment;

FIG. 17 is a flowchart of virtualization environment information acquisition process according to an embodiment;

FIG. 18 is a flowchart of backup information acquisition process according to an embodiment;

FIG. 19 is a flowchart of container environment information acquisition process according to an embodiment;

FIG. 20 is a flowchart of rebalancing priority and rebalancing path selection process according to an embodiment;

FIG. 21 is a diagram showing an example of a state of nodes and a backup storage apparatus according to an embodiment;

FIG. 22 is a diagram illustrating generation of a rebalancing path table according to an embodiment;

FIG. 23 is a flowchart of completion prediction time calculation process according to an embodiment;

FIG. 24 is a flowchart of node information notification process according to an embodiment;

FIG. 25 is a flowchart of rebalancing control process according to an embodiment; and

FIG. 26 is a flowchart of rebalancing instruction process according to an embodiment.

### DETAILED DESCRIPTION OF THE EMBODIMENT

Embodiments will be described with reference to the drawings. The embodiments that will be described below do not limit the invention according to the claims, and all of elements and combinations thereof described in the embodiments are not necessarily essential to the solution of the invention.

In the following description, a reference sign may be used when the same kind of elements are explained without being distinguished, and an element ID may be used when the same kind of elements are distinguished. For example, when nodes are not distinguished, they are referred to as “node 220,” and when the nodes are distinguished, they are referred to as “node n1,” “node n2,” and “node n3.”

Further, in the following description, an “interface unit” includes one or more interfaces. One or more interfaces may be one or more interface devices of the same type (for example, one or more NICs (Network Interface Cards)) or two or more heterogeneous interface devices (for example, NIC and HBA (Host Bus Adapter)).

Further, in the following description, a “memory unit” includes one or more memories. At least one memory may be a volatile memory or a non-volatile memory. The memory unit is mainly used during process performed by a processor unit.

Further, in the following description, a “processor unit” includes one or more processors. At least one processor is typically a microprocessor such as a CPU (Central Processing Unit). Each of the one or more processors may be single-core or multi-core. The processor may include a hardware circuit that performs a part or all of process.

Further, although information may be described by an expression such as “AAA table” in the following description, information may be expressed by any data structure. That is, “AAA table” can be referred to as “AAA information” in order to represent that information does not depend on a data structure. Further, in the following description, the configuration of each table is an example, and one table may be divided into two or more tables or all or some of two or more tables may be one table.

Further, although a processing unit (function) may be described by an expression of “kkk unit” in the following description, the processing unit may be realized by a processor unit executing one or more computer programs or may be realized by one or more hardware circuits (for example, FPGAs or ASICs (Application Specific Integrated Circuits)). When the processing unit is realized by a program through the processor unit, specified process is appropriately performed using storage resources (for example, a memory) and/or a communication interface device (for example, a communication port), and thus the processing unit may be at least a part of the processor unit. Process described with the processing unit as the operating subject may be assumed to be process performed by the processor unit or an apparatus having the processor unit. Further, the processor unit may include a hardware circuit that performs a part or all of process. The program may be installed in a processor from a program source. The program source may be, for example, a program distribution computer or a computer-readable recording medium (for example, a non-transitory recording medium). The description of each processing unit is an example, and a plurality of processing units may be combined into one processing unit or one processing unit may be divided into a plurality of processing units.

Further, although processing may be described with a “program” as an operation subject in the following description, the program is executed by the processor unit such that specified process is appropriately performed using at least one of a memory unit and an interface unit, and thus the operation subject of the process may be a processor unit (or a computer having the processor unit). The program may be installed in a computer from a program source. The program source may be, for example, a program distribution server or a computer-readable storage medium. Further, in the following description, two or more programs may be realized as one program, or one program may be realized as two or more programs.

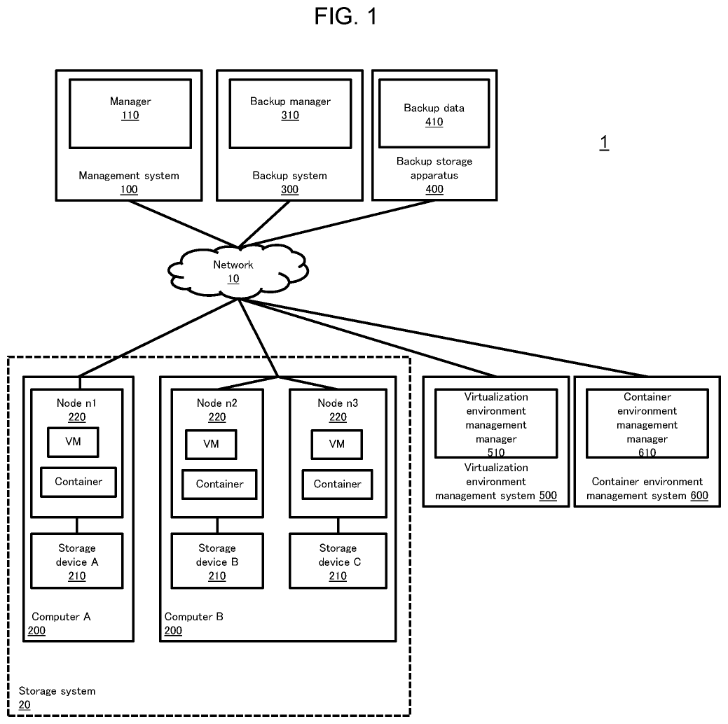

FIG. 1 is an overall configuration diagram of a computer system according to an embodiment.

The computer system 1 includes a storage system 20, a management system 100, a backup system 300, a backup storage apparatus 400 as an example of a backup apparatus, a virtualization environment management system 500, and a container environment management system 600. The storage system 20, the management system 100, the backup system 300, the backup storage apparatus 400, the virtualization environment management system 500, and the container environment management system 600 are coupled so that they can communicate via a network 10. The network 10 is, for example, an IP (Internet Protocol) network. The backup storage apparatus 400 may be configured on the backup system 300, and in short, it may be any apparatus that can access backup data via the network 10.

The management system 100 executes a manager 110.

The backup system 300 executes a backup manager 310. The backup storage apparatus 400 stores volume data (backup data) 410 of the storage system 20 backed up by the backup system 300.

The storage system 20 includes one or more computers 200 (for example, computers A and B) and includes a plurality of nodes 220. The computer 200 includes one or more nodes 220 and one or more storage devices 210. The node 220 is configured by a computer program executed in the computer 200. The number of nodes 220 of the computer 200 and the number of storage devices 210 are the same and one-to-one correspond to each other. In FIG. 1, nodes n1 to n3 correspond to storage devices A to C, respectively. In the storage system 20, the same volume (an example of a data unit) is stored in the plurality of storage devices 210 corresponding to the plurality of nodes 220 in order to ensure redundancy. At node 220, a VM (virtual machine) or a container that executes various types of work process is configured.

The virtualization environment management system 500 executes a virtualization environment management manager 510. The virtualization environment management manager 510 manages a VM to be constructed at the node 220. The container environment management system 600 executes a container environment management manager 610. The container environment management manager 610 manages a container to be constructed at the node 220.

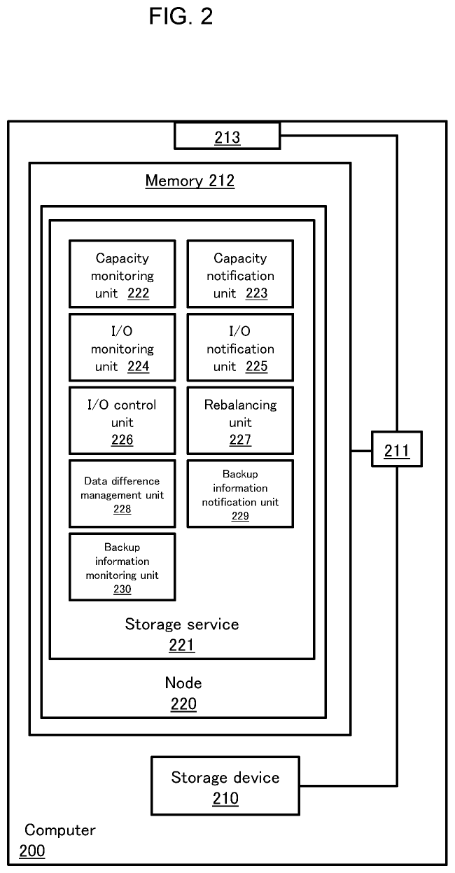

FIG. 2 is a configuration diagram of the computer according to an embodiment.

The computer 200 includes a storage device 210, a processor 211, a memory 212, and a network I/F (network interface) 213.

The storage device 210 is typically a physical non-volatile storage device and is, for example, one or more HDDs (Hard Disk Drives) or SSDs (Solid State Drives). The storage device 210 stores various types of data.

The network I/F 213 is, for example, an interface such as a wired LAN card or a wireless LAN card and communicates with other apparatuses (for example, the management system 100 and the backup system 300) via the network 10.

The processor 211 executes various types of processes according to programs stored in the memory 212 and/or the storage device 210.

The memory 212 is an example of a memory unit and stores the node 220. The node 220 is executed by the processor 211.

The node 220 provides a logical storage space of the storage device 210 corresponding to the node 220 to, for example, an application executed by the VM in the computer 200 or an application outside the computer 200. The node 220 accepts an I/O request for the logical storage space and executes data writing or reading for the storage device 210 corresponding to the node 220 according to the I/O request (transmits an I/O command to the storage device 210). The node 220 can transfer write target data (I/O request of write target data) to the storage device 210 corresponding thereto to a node 220 (for example, a node 220 in another computer 200) coupled to another storage device 210, for example, in order to maintain data redundancy. The node 220 may be, for example, an SDS (Software Defined Storage). The node 220 has a storage service 221.

The storage service 221 corresponds to a virtual storage controller that accepts an I/O request and executes data writing or reading for the storage device 210 according to the I/O request. The storage service 221 includes a capacity monitoring unit 222, a capacity notification unit 223, an I/O monitoring unit 224, an I/O notification unit 225, an I/O control unit 226, a rebalancing unit 227, a data difference management unit 228, a backup information notification unit 229, and a backup information monitoring unit 230.

The capacity monitoring unit 222 monitors the capacity of a storage device 210 corresponding to a node 220 to which it belongs (referred to as an own node) (for example, periodically checks it). The capacity notification unit 223 notifies the manager 110 of information on a capacity specified by the capacity monitoring unit 222.

The I/O monitoring unit 224 monitors the I/O load of the own node 220. In the present embodiment, the I/O load monitored by the I/O monitoring unit 224 includes a usage rate of the storage device 210 of the own node and a usage rate (path usage rate) of a communication path via the network I/F 213 of the own node 220. The I/O notification unit 225 notifies the manager 110 of the I/O load specified by the I/O monitoring unit 224. The I/O control unit 226 controls the usage rate of the communication path of the own node 220 via the network I/F 213. For example, the I/O control unit 226 can control the usage rate of the communication path of the own node 220 via the network I/F 213 such that the usage rate does not exceed a predetermined threshold value. The rebalancing unit 227 executes rebalancing process for transferring data according to an instruction from the manager 110.

The data difference management unit 228 manages information indicating a difference cross-section (difference cross-section information) from data (volume) at a predetermined time point. The backup information notification unit 229 notifies the manager 110 of information on a backup specified by the backup information monitoring unit 230. The backup information monitoring unit 230 monitors backup of data of the storage device 210 of the own node.

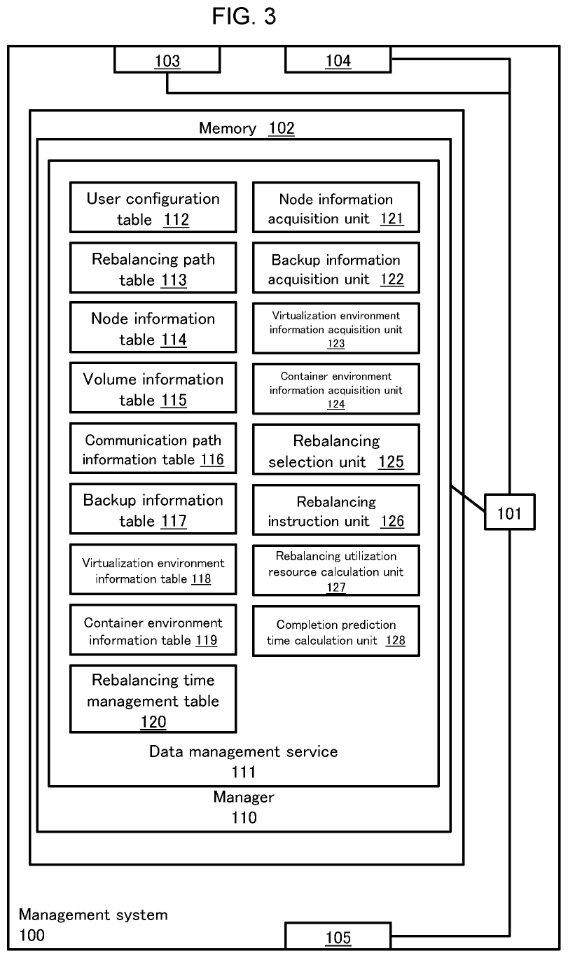

FIG. 3 is a configuration diagram of the management system according to an embodiment.

The management system 100 includes a processor 101, a memory 102, an input device 103, an output device 104, and a network I/F 105.

The input device 103 is, for example, a keyboard and a pointing device and accepts various inputs. The output device 104 is, for example, a display device such as a liquid crystal display, and displays and outputs various types of information. The input device 103 and the output device 104 may be integrated into a component such as a touch panel, for example.

The processor 101 executes various types of processes according to programs stored in the memory 102.

The memory 102 is an example of a memory unit and stores the manager 110. The manager 110 is executed by the processor 101.

The manager 110 includes a data management service 111.

The data management service 111 executes process of acquiring various types of information from the node 220, determining a transmission path (at least a node that is a transmission source) of a data unit to be rebalanced on the basis of the various types of information, and transmitting an instruction (rebalancing instruction) for process of rebalancing data corresponding to the determined content to the node 220. The data management service 111 includes a node information acquisition unit 121, a backup information acquisition unit 122, a virtualization environment information acquisition unit 123, a container environment information acquisition unit 124, a rebalancing selection unit 125, a rebalancing instruction unit 126, a rebalancing utilization resource calculation unit 127, and a completion prediction time calculation unit 128. Further, the data management service 111 manages a user configuration table 112, a rebalancing path table 113, a node information table 114, a volume information table 115, a communication path information table 116, a backup information table 117, and virtualization environment information table 118, a container environment information table 119, and a rebalancing time management table 120.

The node information acquisition unit 121 receives capacity information of the storage device 210 and I/O information of the node 220 from each node 220 and registers the received information in the node information table 114, the volume information table 115, and the communication path information table 116. The backup information acquisition unit 122 detects whether or not backup data of data exists, receives backup information of backed-up data from the backup system 300, and registers the backup information in the backup information table 117. The virtualization environment information acquisition unit 123 receives information on a VM in each node 220 from the virtualization environment management system 500 and registers the information in the virtualization environment information table 118. The container environment information acquisition unit 124 receives information on a container in each node 220 from the container environment management system 600 and registers the information in the container environment information table 119.

The rebalancing selection unit 125 performs process of selecting a path for transferring data of a volume of a rebalance target. The rebalancing instruction unit 126 transmits an instruction (rebalancing instruction) for transferring the volume through the path selected by the rebalancing selection unit 125 to the rebalancing unit 227 of the node 220. The rebalancing utilization resource calculation unit 127 detects capacity depletion of the storage device 210 of each node 220. The completion prediction time calculation unit 128 calculates a time when rebalancing selected by the rebalancing selection unit 125 is expected to be completed.

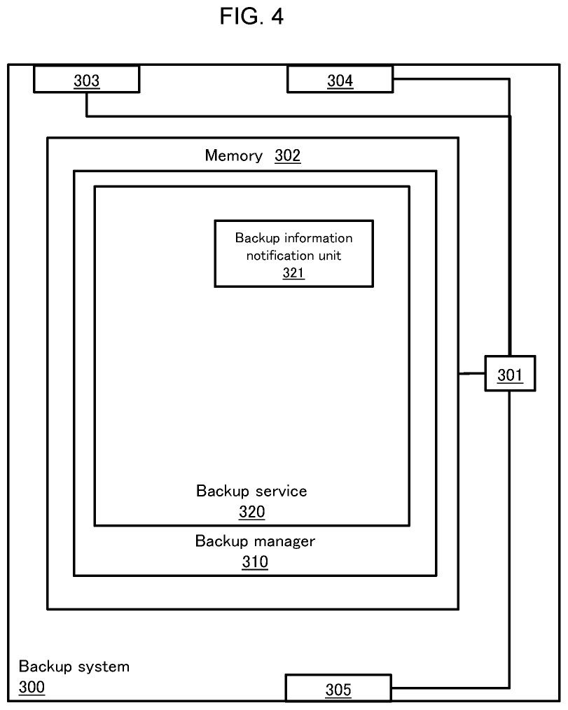

FIG. 4 is a configuration diagram of the backup system according to an embodiment.

The backup system 300 includes a processor 301, a memory 302, an input device 303, an output device 304, and a network I/F 305.

The input device 303 is, for example, a keyboard and a pointing device and accepts various inputs. The output device 304 is, for example, a display device such as a liquid crystal display, and displays and outputs various types of information. The input device 303 and the output device 304 may be integrated into a component such as a touch panel, for example.

The network I/F 305 is, for example, an interface such as a wired LAN card or a wireless LAN card and communicates with other apparatuses (for example, the computer 200 and the backup storage apparatus 400) via the network 10.

The processor 301 executes various types of processes according to programs stored in the memory 302.

The memory 302 is an example of a memory unit and stores the backup manager 310. The backup manager 310 is executed by the processor 301.

The backup manager 310 has a backup service 320.

The backup service 320 performs process of storing backup data of data stored in the storage device 210 of the storage system 20 in the backup storage apparatus 400. Data backup is performed, for example, in units of volumes (an example of data units). The backup service 320 has a backup information notification unit 321. The backup information notification unit 321 transmits information (backup information) regarding backup of the data stored in the storage device 210 to the computer 200. The backup information includes, for example, an identifier (volume ID) of a backed-up volume, data difference cross-section information at the time of backing up backed-up data, and a backup hash.

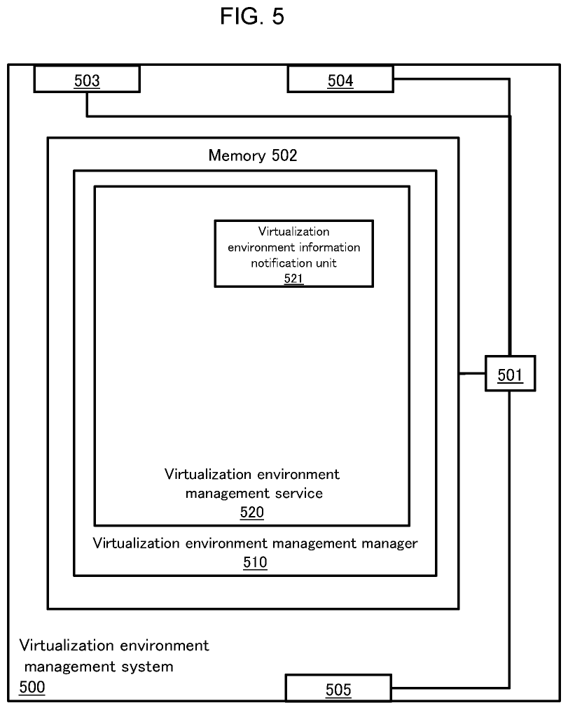

FIG. 5 is a configuration diagram of the virtualization environment management system according to an embodiment.

The virtualization environment management system 500 includes a processor 501, a memory 502, an input device 503, an output device 504, and a network I/F 505.

The input device 503 is, for example, a keyboard and a pointing device and accepts various inputs. The output device 504 is, for example, a display device such as a liquid crystal display, and displays and outputs various types of information. The input device 503 and the output device 504 may be integrated into a component such as a touch panel, for example.

The network I/F 505 is, for example, an interface such as a wired LAN card or a wireless LAN card and communicates with other apparatuses (for example, the computer 200, and the management system 100) via the network 10.

The processor 501 executes various types of processes according to programs stored in the memory 502.

The memory 502 is an example of a memory unit and stores the virtualization environment management manager 510. The virtualization environment management manager 510 is executed by the processor 501.

The virtualization environment management manager 510 has a virtualization environment management service 520.

The virtualization environment management service 520 performs process of generating a VM at the node 220 of the storage system 20 and managing the VM. The virtualization environment management service 520 has a virtualization environment information notification unit 521. The virtualization environment information notification unit 521 transmits information (virtualization environment information) on the VM arranged in the node 220 to the management system 100. The virtualization environment information includes, for example, the node in which the VM is arranged, a volume used by the VM, data locality of the volume of the VM, information on a VM group constituting an HA (High Availability) cluster, and the like.

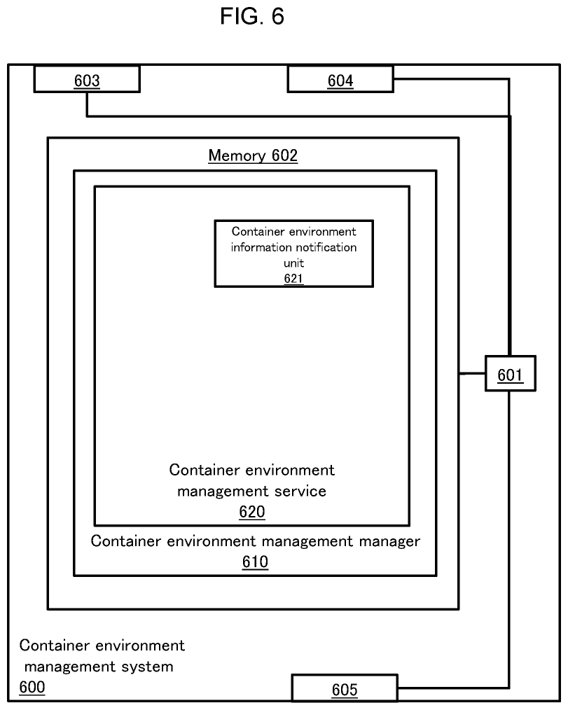

FIG. 6 is a configuration diagram of the container environment management system according to an embodiment.

The container environment management system 600 includes a processor 601, a memory 602, an input device 603, an output device 604, and a network I/F 605.

The input device 603 is, for example, a keyboard and a pointing device and accepts various inputs. The output device 604 is, for example, a display device such as a liquid crystal display, and displays and outputs various types of information. The input device 603 and the output device 604 may be integrated into a component such as a touch panel, for example.

The network I/F 605 is, for example, an interface such as a wired LAN card or a wireless LAN card and communicates with other apparatuses (for example, the computer 200 and the management system 100) via the network 10.

The processor 601 executes various types of processes according to programs stored in the memory 602.

The memory 602 is an example of a memory unit and stores the container environment management manager 610. The container environment management manager 610 is executed by the processor 601.

The container environment management manager 610 has a container environment management service 620.

The container environment management service 620 performs processes of generating a container at the node 220 of the storage system 20 and managing the container. The container environment management service 620 has a container environment information notification unit 621. The container environment information notification unit 621 transmits information (container environment information) of the container arranged in the node 220 to the management system 100. The container environment information includes, for example, the node in which the container is arranged, a volume used by the container, data locality information of the volume of the container, and the like.

Next, various tables of the management system 100 will be described.

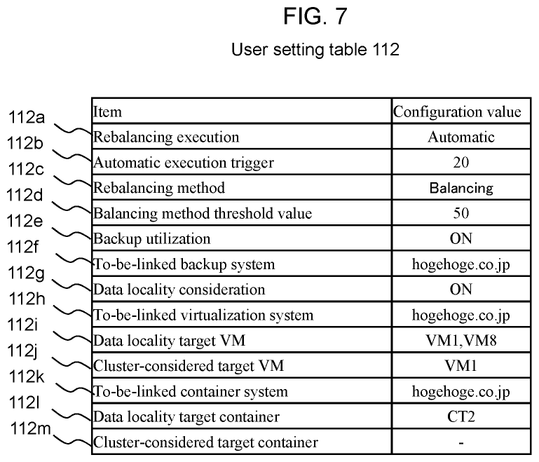

FIG. 7 is a configuration diagram of a user configuration table according to an embodiment.

The user configuration table 112 stores various information configured by a user in the management system 100, for example, via the input device 103. The user configuration table 112 includes items of rebalancing execution 112a, an automatic execution trigger 112b, a rebalancing method 112c, a balancing method threshold value 112d, backup utilization 112e, a to-be-linked backup system 112f, data locality consideration 112g, a to-be-linked virtualization system 112h, a data locality target VM 112i, a cluster-considered target VM 112j, a to-be-linked container system 112k, a data locality target container 112l, and a cluster-considered target container 112m.

The rebalancing execution 112a stores a configuration as to whether to execute rebalancing automatically or manually. The automatic execution trigger 112b stores a condition that becomes a trigger when rebalancing is automatically executed. In the present embodiment, the condition is, for example, a threshold value of a data capacity difference between nodes, and when a data capacity difference between nodes is equal to or larger than the threshold value, rebalancing (specifically, rebalancing preparation process or the like) is executed. The rebalancing method 112c stores a rebalancing method to be executed. The rebalancing method includes performance priority (first configuration) that emphasizes performance maintenance of the storage system 20 (each node 220), speed priority (second configuration) that emphasizes transfer processing efficiency in data units, and balancing (third configuration) that improves transfer processing efficiency in data units in a state in which performance deterioration of the node 220 is kept within an allowable range. The rebalancing method threshold value 112d stores an upper limit of a usage rate (path usage rate) for a bandwidth of a path when balancing is configured as the rebalancing method. Therefore, in the case of balancing configuration, the path usage rate of each node 220 is controlled to be equal to or smaller than a configuration value.

The backup utilization 112e stores a configuration as to whether or not to use backup data in which the volume is backed up in rebalancing. The backup utilization 112e stores, for example, ON when backup data is used and stores OFF when the backup data is not used. The to-be-linked backup system 112f stores a host name indicating a backup system 300 to be linked.

The data locality consideration 112g stores data locality, that is, a configuration as to whether or not it is necessary to consider that data exists locally in rebalancing. Here, data locality means that data should be arranged in the node. The to-be-linked virtualization system 112h stores a host name indicating a virtualization environment management system 500 to be linked. The data locality target VM 112i stores identification information (virtual machine ID) indicating a VM that is a target of data locality. The cluster-considered target VM 112j stores identification information indicating a VM for which a cluster needs to be considered. The to-be-linked container system 112k stores a host name indicating a container environment management system 600 to be linked. The data locality target container 1121 stores identification information (container ID) indicating a container that is a target of data locality. The cluster-considered target container 112m stores identification information indicating a container for which a cluster needs to be considered.

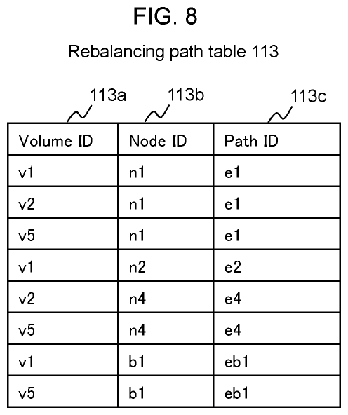

FIG. 8 is a configuration diagram of a rebalancing path table according to an embodiment.

The rebalancing path table 113 is a table that manages paths for transferring data in rebalancing and stores entries for each path. Paths include at least a node and may include a cable, a physical port and a virtual port of a communication I/F. The entry of the rebalancing path table 113 includes columns of a volume ID 113a, a node ID 113b, and a path ID 113c.

The volume ID 113a stores an identifier (volume ID) that uniquely identifies a volume that can be rebalanced (transferred) through a path corresponding to the entry in the storage system 20. The node ID 113b stores an identifier (node ID) that uniquely identifies a node 220 that manages the volume corresponding to the entry in the storage system 20. In the present embodiment, the node ID 113b may also store an ID indicating the backup storage apparatus 400 although it is not the node 220. In FIG. 8, a node ID including b, like b1, indicates the ID of the backup storage apparatus 400. For convenience, the backup storage apparatus 400 may be referred to as a node. The path ID 113c stores an ID (path ID) of a path corresponding to the entry.

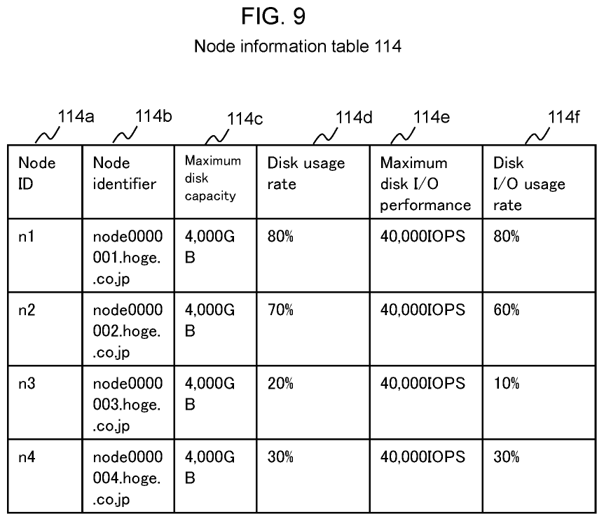

FIG. 9 is a configuration diagram of a node information table according to an embodiment.

The node information table 114 stores information about the storage device 210 corresponding to the node 220. The node information table 114 stores entries for each node. The entry of the node information table 114 includes columns of a node ID 114a, a node identifier 114b, a maximum disk capacity 114c, a disk usage rate 114d, maximum disk I/O performance 114e, and a disk I/O usage rate 114f.

The node ID 114a stores a node ID of a node 220 corresponding to the entry. The node identifier 114b stores an identifier (node identifier) of the node 220 corresponding to the entry. The node identifier is an identifier that is unique in a wider range than the node ID. The maximum disk capacity 114c stores a maximum capacity of all storage devices 210 of the node 220 corresponding to the entry. The disk usage rate 114d stores a usage rate of a storage area of the storage device 210 of the node 22 corresponding to the entry. The maximum disk I/O performance 114e stores maximum performance with respect to I/O of the storage device 210 of the node 220 corresponding to the entry. The performance with respect to I/O is represented by, for example, IOPS (Input/output per second). The disk I/O usage rate 114f stores a usage rate with respect to I/O of the storage device 210 of the node 220 corresponding to the entry.

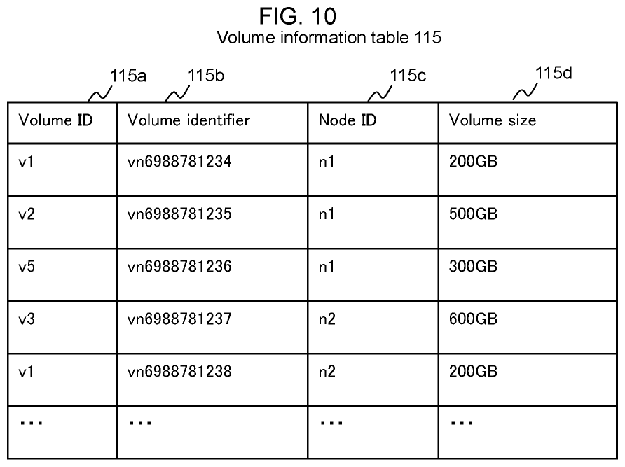

FIG. 10 is a configuration diagram of a volume information table according to an embodiment.

The volume information table 115 stores information about volumes. The volume information table 115 stores entries for each volume. The entry of the volume information table 115 includes columns of a volume ID 115a, a volume identifier 115b, a node ID 115c, and a volume size 115d.

The volume ID 115a stores a volume ID of a volume corresponding to the entry. The volume identifier 115b stores an identifier (volume identifier) of the volume corresponding to the entry. The volume identifier is an identifier that is unique in a wider range than the volume ID. The node ID 115c stores a node ID of a node 220 coupled to a storage device 210 that stores the volume corresponding to the entry. The volume size 115d stores the size of the volume corresponding to the entry.

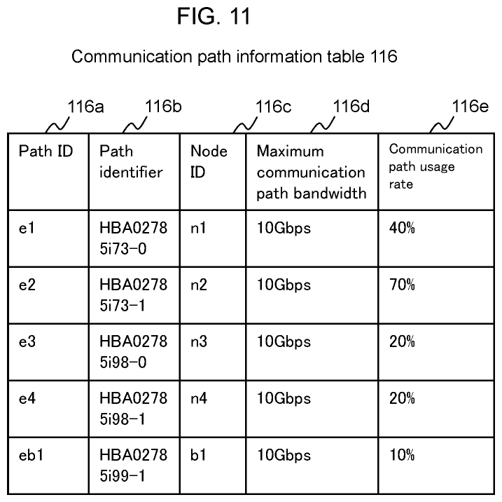

FIG. 11 is a configuration diagram of a communication path information table according to an embodiment.

The communication path information table 116 stores information about paths for performing data communication of the node 220. The communication path information table 116 stores entries for each path. The entry of the communication path information table 116 includes columns of a path ID 116a, a path identifier 116b, a node ID 116c, a maximum communication path bandwidth 116d, and a communication path usage rate 116e.

The path ID 116a stores a unique ID (path ID) within a management range of the management system 100 of a path corresponding to an entry. The path identifier 116b stores an identifier (path identifier) of the path corresponding to the entry. The path identifier is an identifier that is unique in a wider range than the path ID and may be, for example, a WWN (World Wide Name) of a network I/F. The node ID 116c stores a node ID of a node 220 that is a transmission source of the path corresponding to the entry. The maximum communication path bandwidth 116d stores a value of a maximum bandwidth in the path corresponding to the entry. The communication path usage rate 116e stores a usage rate (path usage rate, an example of I/O load) of a bandwidth of the path corresponding to the entry.

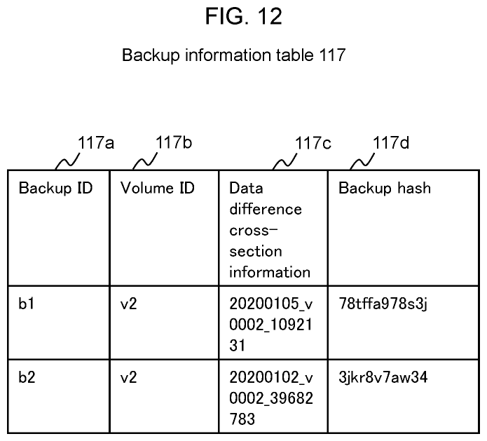

FIG. 12 is a configuration diagram of a backup information table according to an embodiment.

The backup information table 117 stores information (backup information) of a volume backed up by the backup system 300. The backup information table 117 stores entries for each of volume backup process. The entry of the backup information table 117 includes columns of a backup ID 117a, a volume ID 117b, data difference cross-section information 117c, and a backup hash 117d.

The backup ID 117a stores an identifier (backup ID) corresponding to backup process corresponding to the entry. The volume ID 117b stores a volume ID of a volume that is a target of backup process corresponding to the entry. The data difference cross-section information 117c stores information indicating information (data difference cross-section information) capable of specifying a difference portion from a state of the volume corresponding to the entry at a predetermined time point. By comparing this data difference cross-section information, it is possible to ascertain a part where there is a difference for the same volume. The backup hash 117d stores a hash value for the volume corresponding to the entry.

For example, the first row represents that a volume with a volume ID of v2 is backed up, data difference cross-section information of the volume is data of 20200105_v0002_1092131, and a hash value of the volume is 78tffa978s3j in backup process with a backup ID of b1.

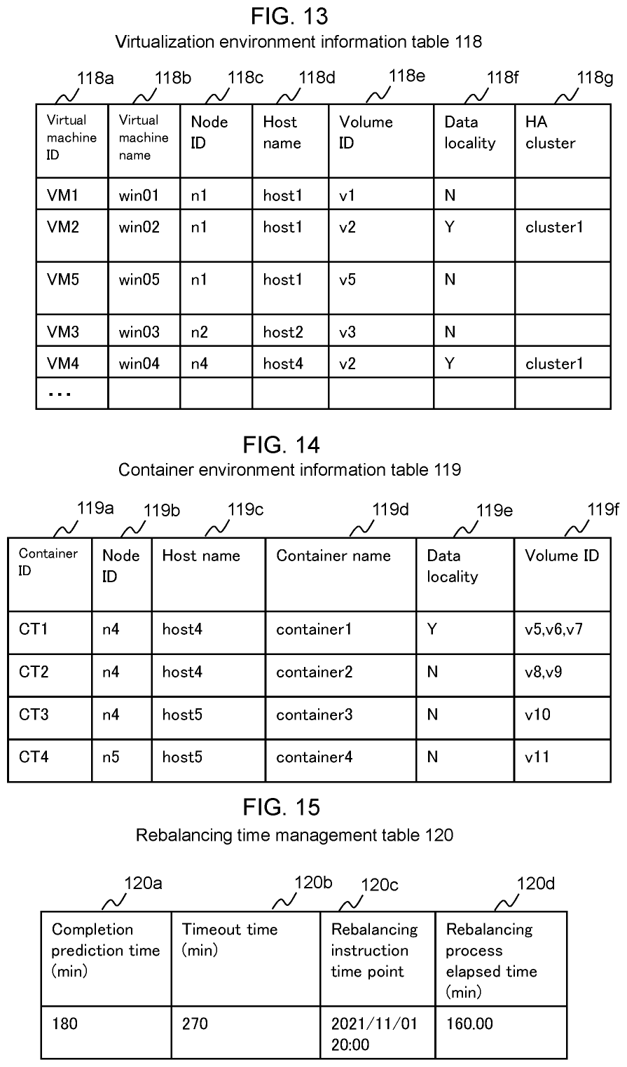

FIG. 13 is a configuration diagram of a virtualization environment information table according to an embodiment.

The virtualization environment information table 118 stores information on a virtualization environment in the storage system 20. The virtualization environment information table 118 stores entries for each VM of the storage system 20. The entry of the virtualization environment information table 118 includes columns of a virtual machine ID 118a, a virtual machine name 118b, a node ID 118c, a host name 118d, a volume ID 118e, data locality 118f, and an HA cluster 118g.

The virtual machine ID 118a stores a virtual machine ID of a VM corresponding to the entry. The virtual machine name 118b stores the name (virtual machine name) of the VM corresponding to the entry. The node ID 118c stores a node ID of a node 220 in which the VM corresponding to the entry is configured. The host name 118d stores a host name of a node allocated to the VM corresponding to the entry. The volume ID 118e stores a volume ID of a volume used by the VM corresponding to the entry. The data locality 118f stores a configuration (arrangement designation information) as to whether or not data locality with respect to the volume used by the VM corresponding to the entry is required. Here, a volume for which data locality is configured to be required corresponds to an arrangement designated data unit. The HA cluster 118g stores the cluster name of a HA cluster configured by the VM corresponding to the entry. According to the cluster name of the HA cluster 118g, it can be ascertained that an HA cluster is configured by VMs of a plurality of entries having the same cluster name.

FIG. 14 is a configuration diagram of a container environment information table according to an embodiment.

The container environment information table 119 stores information on a container environment in the storage system 20. The container environment information table 119 stores entries for each container of the storage system 20. The entry of the container environment information table 119 includes columns of a container ID 119a, a node ID 119b, a host name 119c, a container name 119d, data locality 119e, and a volume ID 119f.

The container ID 119a stores an identifier (container ID) of a container corresponding to the entry. The node ID 119b stores a node ID of a node 220 in which the container corresponding to the entry is configured. The host name 119c stores a host name of a node to which the container corresponding to the entry is allocated. The container name 119d stores the name (container name) of the container corresponding to the entry. The data locality 119e stores a configuration as to whether or not data locality with respect to a volume used by the container corresponding to the entry is required. The volume ID 119f stores a volume ID of the volume used by the container corresponding to the entry.

FIG. 15 is a configuration diagram of a rebalancing time management table according to an embodiment.

The rebalancing time management table 120 stores information regarding a time of rebalancing process according to a path of the rebalancing path table 113. The rebalancing time management table 120 includes columns of a completion prediction time 120a, a timeout time 120b, a rebalancing instruction time point 120c, and a rebalancing process elapsed time 120d.

The completion prediction time 120a stores a rebalancing process completion prediction time. The timeout time 120b stores a time (timeout time) for time-out of rebalancing process. The rebalancing instruction time point 120c stores a time point (instructed time point) at which execution of rebalancing process is instructed. The rebalancing process elapsed time 120d stores an elapsed time since rebalancing process is executed.

Next, a processing operation of the computer system 1 will be described.

First, rebalancing preparation process in the computer system 1 will be described.

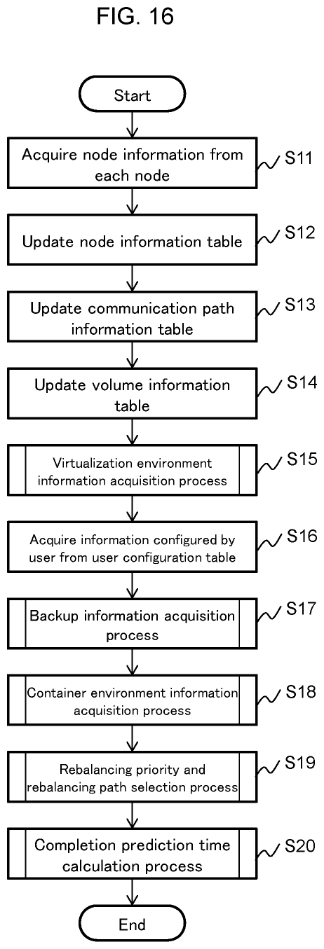

FIG. 16 is a flowchart of rebalancing preparation process according to an embodiment.

The rebalancing preparation process is executed, for example, when conditions for executing rebalancing are satisfied or when a user designates the rebalancing preparation process.

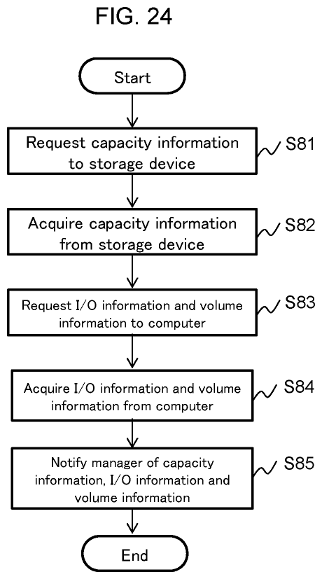

The node information acquisition unit 121 of the management system 100 requests node information to a predetermined management target node 220 and acquires the node information (step S11). Note that each node 220 that has received the node information request notifies the node information acquisition unit 121 of node information by executing node information notification process (refer to FIG. 24). Here, the node information includes, for example, disk information of the storage device 210, I/O information of the node 220, and volume information. The disk information may include, for example, a maximum disk capacity of the storage device 210, a disk usage rate, maximum disk I/O performance, a disk I/O usage rate, and the like. The I/O information may include information on a communication path of the node 220, for example, a path identifier, a node ID, a maximum communication path bandwidth, a communication path usage rate, and the like. The volume information may include, for example, a volume ID, a volume identifier, a node ID, a volume size, and the like.

Next, the node information acquisition unit 121 updates the node information table 114 on the basis of acquired disk information (step S12), updates the communication path information table 116 on the basis of the I/O information (step S13), and updates the volume information table 115 on the basis of the volume information (step S14).

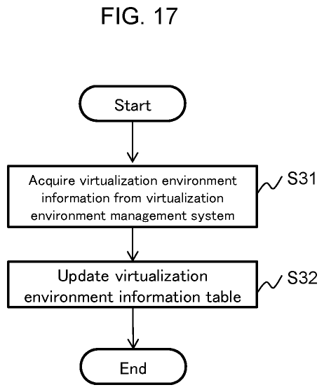

Next, the virtualization environment information acquisition unit 123 starts execution of virtualization environment information acquisition process (refer to FIG. 17) (step S15). According to this virtualization environment information acquisition process, the virtualization environment information table 118 is updated.

After completion of virtualization environment information process, the backup information acquisition unit 122 acquires information configured by the user from the user configuration table 112 (step S16). In the present embodiment, the backup information acquisition unit 122 acquires a configuration of a rebalancing method, a backup usage configuration, a configuration of linkage with a virtualization environment management system, a configuration of linkage with a container environment management system, and the like. After completion of virtualization environment information process, the management system 100 may accept a configuration of the user for some information in the user configuration table 112 (for example, a VM targeted for a data locality target VM or the like) and store the configuration in the user configuration table 112.

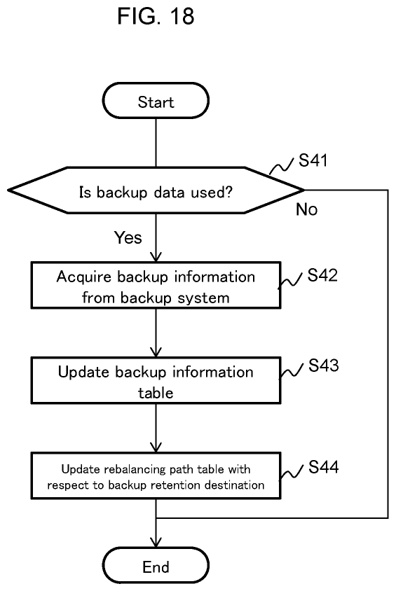

Next, the backup information acquisition unit 122 starts execution of backup information acquisition process (refer to FIG. 18) (step S17). According to this backup information acquisition process, the backup information table 117 is updated in the case of configuration for using backup data.

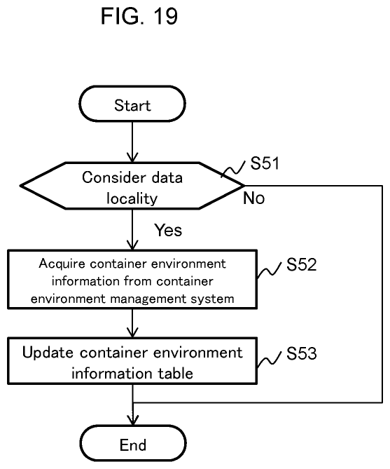

Next, the container environment information acquisition unit 124 starts execution of container environment information acquisition process (refer to FIG. 19) (step S18). According to this container environment information acquisition process, the container environment information table 119 is updated.

After completion of container environment information acquisition process, the rebalancing selection unit 125 executes rebalancing priority and rebalancing path selection process (step S19). According to this rebalancing priority and rebalancing path selection process, a path used for rebalancing is registered in the rebalancing path table 113.

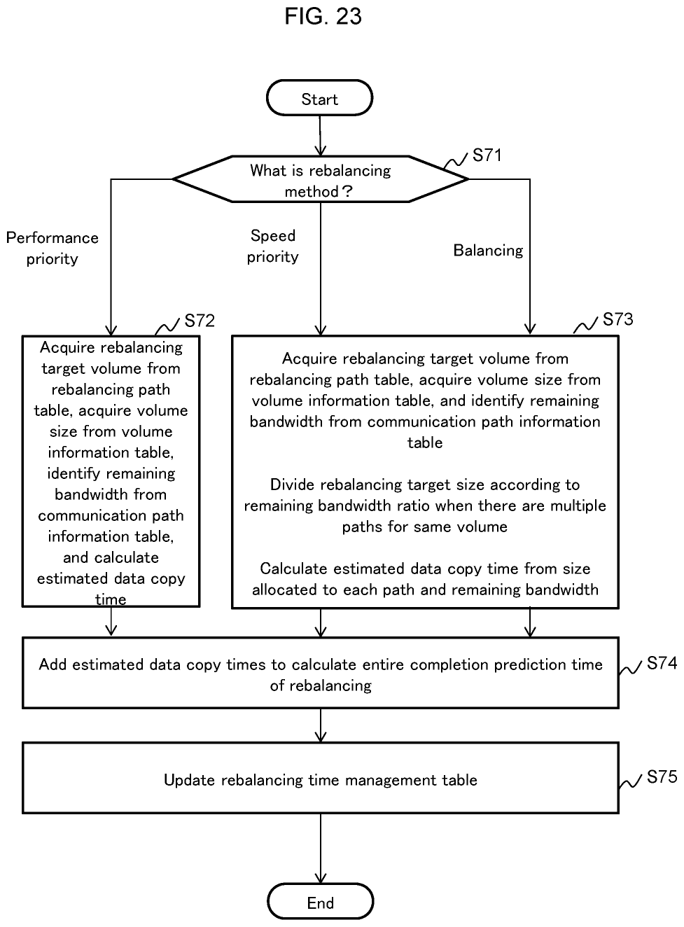

Next, the completion prediction time calculation unit 128 executes completion prediction time calculation process (refer to FIG. 23) (step S20) and ends rebalancing preparation process. According to the completion prediction time calculation process, a prediction time (completion prediction time) until rebalancing process using the path registered in the rebalancing path table 113 is completed is calculated and registered in the rebalancing time management table 120. The completion prediction time calculation unit 128 may notify the user of the completion prediction time registered in the rebalancing time management table 120 (for example, display and output to a user's terminal).

Next, virtualization environment information acquisition process (step S15) will be described.

FIG. 17 is a flowchart of virtualization environment information acquisition process according to an embodiment.

The virtualization environment information acquisition unit 123 acquires virtualization environment information (virtual machine ID, virtual machine name, node ID, host name, volume ID, data locality, and HA cluster regarding a VM) from the virtualization environment management system 500 (step S31).

Next, the virtualization environment information acquisition unit 123 updates the virtualization environment information table 118 on the basis of the acquired virtualization environment information (step S32) and ends the virtualization environment information acquisition process.

Next, backup information acquisition process (step S17) will be described.

FIG. 18 is a flowchart of backup information acquisition process according to an embodiment.

The backup information acquisition unit 122 determines whether or not backup utilization is configured in the user configuration table 112 (step S41), and if backup utilization is not configured (No in step S41), ends the backup information acquisition process.

On the other hand, if backup utilization is configured (Yes in step S41), the backup information acquisition unit 122 acquires backup information from the backup system 300 (step S42). Specifically, the backup information acquisition unit 122 requests acquisition of backup information to the backup information monitoring unit 230 of each node 220, the backup information monitoring unit 230 that has received the request requests the backup information to the backup system 300 and receives a backup ID, data difference cross-section information, and a backup hash corresponding to a backed-up volume from the backup manager 310 of the backup system 300 as the backup information, and the backup information notification unit 229 notifies the backup information acquisition unit 122 of the backup information received by the backup information monitoring unit 230 in association with the volume ID corresponding to the backup information.

Next, the backup information acquisition unit 122 registers the acquired information in the backup information table 117 (step S43). Accordingly, the latest status of volumes backed up by the backup system 300 is reflected in the backup information table 117. Next, the backup information acquisition unit 122 adds a path for volumes stored in a backup retention destination (the backup storage apparatus 400 in the present embodiment) to the rebalancing path table 113 (step S44) and ends process.

Next, the container environment information acquisition process (step S18) will be described.

FIG. 19 is a flowchart of container environment information acquisition process according to an embodiment.

The container environment information acquisition unit 124 determines whether or not the user configuration table 112 has been configured such that data locality is considered (step S51), and if it has not been configured such that data locality is considered (No in step S51), ends the container environment information acquisition process.

On the other hand, if the user configuration table 112 has been configured such that data locality is considered (Yes in step S51), the container environment information acquisition unit 124 acquires container environment information (container ID, node ID, host name, container name, data locality, and volume ID corresponding to a container) from the container environment management system 600 (step S52).

Next, the container environment information acquisition unit 124 updates the container environment information table 119 on the basis of the acquired container environment information (step S53) and ends the container environment information acquisition process.

Next, the rebalancing priority and rebalancing path selection process (step S19) will be described.

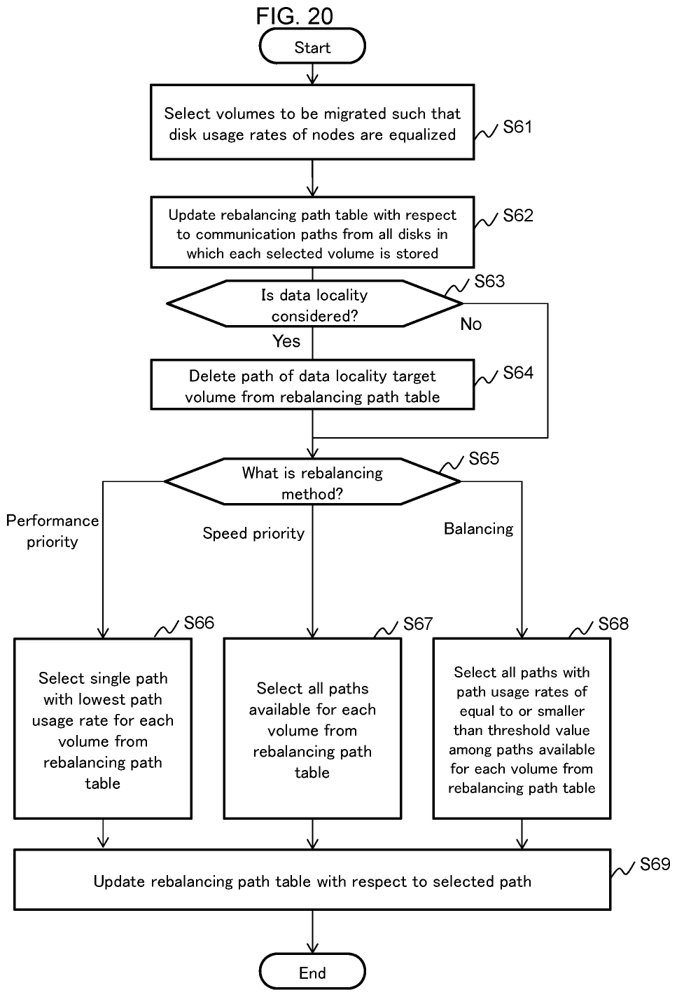

FIG. 20 is a flowchart of rebalancing priority and rebalancing path selection process according to an embodiment.

The rebalancing selection unit 125 of the management system 100 selects volumes to be migrated (rebalanced) such that disk usage rates of the storage devices 210 of the plurality of nodes 220 of the storage system 20 are equalized with reference to the node information table 114 and the volume information table 115 (step S61). Specifically, for example, the rebalancing selection unit 125 identifies a node 220 with a highest disk usage rate and a node 220 with a lowest disk usage rate with reference to the disk usage rates in the disk usage rate 114d in the node information table 114, and selects one or more volumes from volumes that are present in the node 220 (rebalancing target node) with the highest disk usage rate and are not present in the node 220 with the lowest disk usage rate as rebalancing target volumes. It is desirable that a volume selected as the rebalancing target volume is a volume having such a data size that, when the volume has migrated from the node 220 with the highest disk usage rate to the node 220 with the lowest disk usage rate, the disk usage rates of these nodes 220 become equal to or smaller than a predetermined disk usage rate. Here, the selected node 220 with the lowest disk usage rate becomes a transfer destination node to which volumes are transmitted according to rebalancing.

Next, the rebalancing selection unit 125 registers all communication path entries from each node (also including the backup storage apparatus 400) having a storage device 210 in which each selected volume is stored in the rebalancing path table 113 (step S62).

Next, the rebalancing selection unit 125 determines whether or not the configuration considers data locality in rebalancing process (step S63). Here, whether or not the configuration considers data locality can be determined by the value of the data locality consideration 112g in the user configuration table 112.

As a result, if the configuration does not consider data locality in rebalancing process (No in step S63), the rebalancing selection unit 125 proceeds with the process to step S65. On the other hand, if the configuration considers data locality in rebalancing process (Yes in step S63), the rebalancing selection unit 125 deletes a path entry for a data locality target volume from the rebalancing path table 113 (step S64) and proceeds with the process to step S65. Although the data locality target volume is finally prevented from being transferred according to rebalancing by deleting the path of the data locality target volume from the rebalancing path table 113 after the paths for the volumes selected in step S61 are registered in the rebalancing path table 113 in this process, the present disclosure is not limited thereto, and for example, the data locality target volume may not be selected in step S61.

In step S65, the rebalancing selection unit 125 determines whether configuration of the rebalancing method is any one of performance priority, speed priority, and balancing. Here, configuration of the rebalancing method can be determined by the value of the rebalancing method 112c in the user configuration table 112.

If it is determined in step S65 that the rebalancing method is performance priority (step S65: performance priority), the rebalancing selection unit 125 selects, as a path to be used, one path with a lowest path usage rate for each volume from the rebalancing path table 113 (step S66), and process proceeds to step S69.

If it is determined in step S65 that the rebalancing method is speed priority (step S65: speed priority), the rebalancing selection unit 125 selects, as a path to be used, an available path for each volume from the rebalancing path table 113, and if there are a plurality of available paths, selects the plurality of paths as paths to be used (step S67), and process proceeds to step S69. In the present embodiment, a path from the backup storage apparatus 400 may not be selected as a path to be used in the case of speed priority.

If it is determined in step S65 that the rebalancing method is balancing (step S65: balancing), the rebalancing selection unit 125 selects, as paths to be used, all paths having path usage rates of equal to or smaller than a set threshold value (value of the balancing method threshold value 112d in the user configuration table 112) for each volume among available paths from the rebalancing path table 113 (step S68), and process proceeds to step S69.

In step S69, the rebalancing selection unit 125 updates the rebalancing path table 113 only to the entries of the paths selected in steps S66, S67, and S68 (step S69).

The rebalancing path table 113 at this time indicates paths actually used in rebalancing process, and thereafter, the rebalancing process is performed using paths registered in the rebalancing path table 113. Therefore, when performance priority is configured, a target volume is transferred using one path having the lowest path usage rate. Accordingly, it is possible to reduce the influence of performance deterioration due to rebalancing process in the storage system 20. Further, when the target volume is transferred through a path including the backup storage apparatus 400 instead of the nodes 220, it is possible to prevent the performance of the storage system 20 from deteriorating.

Further, when speed priority is configured, different parts of the target volume are transferred in parallel through a plurality of paths including a plurality of nodes 220. Accordingly, the target volume can be transferred to a transfer destination node 220 at an early stage, and the target volume of the transfer destination node 220 can be caused to be available at an early stage.

Further, when balancing is configured, different parts of the target volume are transferred in parallel through a plurality of paths having path usage rates of equal to or smaller than a predetermined threshold value. Accordingly, it is possible to transfer the target volume relatively early while curbing a load on paths of the storage system 20, and the target volume of the transfer destination node 220 can be caused to be available at an early stage.

Next, generation of the rebalancing path table in the rebalancing priority and rebalancing path selection process will be described using specific examples.

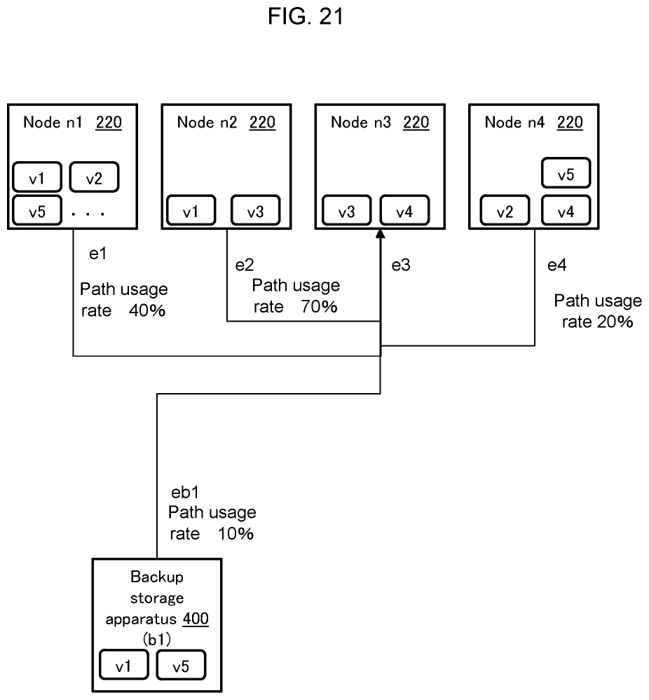

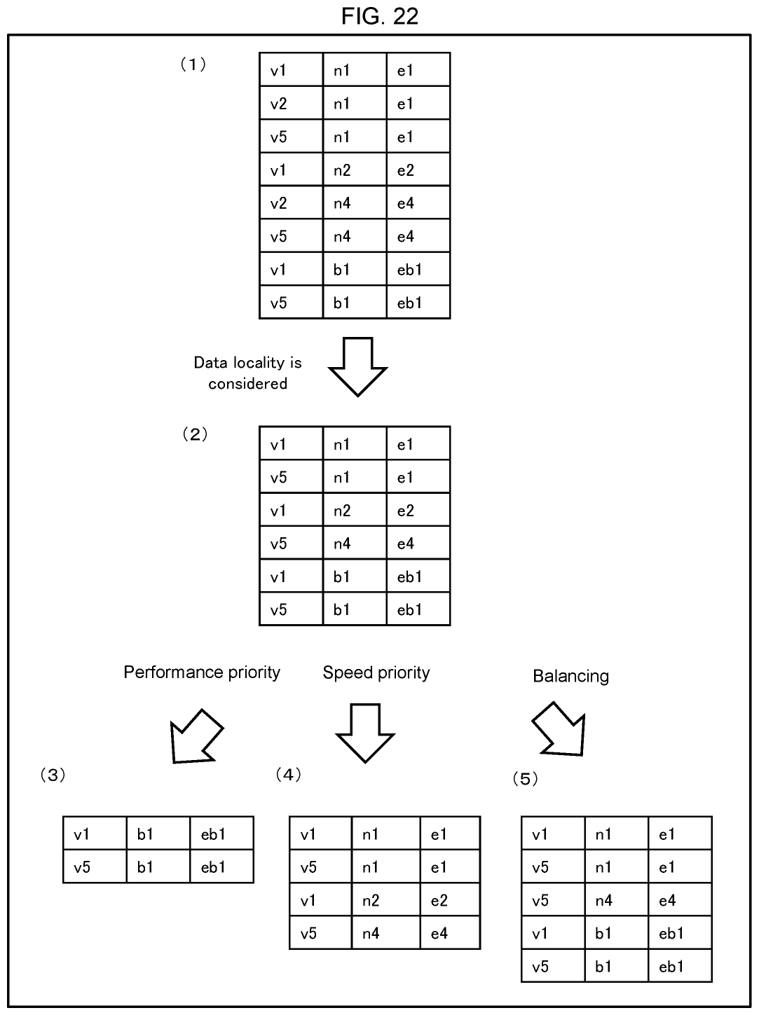

FIG. 21 is a diagram showing an example of a state of nodes and the backup storage apparatus according to an embodiment, and FIG. 22 is a diagram illustrating generation of the rebalancing path table according to an embodiment. FIG. 21 shows the state of the nodes and the backup storage apparatus before execution of the rebalancing priority and rebalancing path selection process, and FIG. 22 shows the rebalancing path table 113 at each time point of the rebalancing priority and rebalancing path selection process. Meanwhile, the node information table 114 of FIG. 9, the volume information table 115 of FIG. 10, and the communication path information table 116 of FIG. 11 have content corresponding to the state of FIG. 21 and are appropriately used in the following description.

Before execution of the rebalancing priority and rebalancing path selection process, a node n1 stores and manages volumes v1, v2, v5 and the like in a coupled storage device 210, a node n2 stores and manages volumes v1 and v3 in a coupled storage device 210, a node n3 stores and manages volumes v3 and v4 in a coupled storage device 210, a node n4 stores and manages volumes v2, v4, and v5 in a coupled storage device 210, and the backup storage apparatus 400 (backup storage apparatus b1) stores volumes v1 and v5. Further, as shown in the node information table 114 of FIG. 9, the disk usage rate of the node n1 is 80%, the disk usage rate of the node n2 is 70%, the disk usage rate of the node n3 is 20%, and the disk usage rate of node n4 is 30%.

Further, as shown in the communication path information table 116 of FIG. 11, the path usage rate of a path e1 of the node n1 is 40%, the path usage rate of a path e2 of the node n2 is 70%, the path usage rate of a path e3 of the node n3 is 20%, the path usage rate of a path e4 of the node n4 is 20%, and the path usage rate of a path eb1 of the backup storage apparatus b1 is 10%.

In this state, in step S61 of the balancing priority and rebalancing path selection process, the node n1 is specified as the node 220 having the highest disk usage rate, and the node n3 is specified as the node 220 having the lowest disk usage rate. Next, one or more volumes among the volumes v1, v2, and v5 that are present in the node n1 and are not present in the node n3 are selected as rebalancing target volumes. Here, the following description will be made on the assumption that the volumes v1, v2, and v5 are selected as the rebalancing target volumes.

Next, in step S62, all paths in which the volumes v1, v2, and v5 are stored are registered in the rebalancing path table 113. In this example, the rebalancing path table 113 is in a state shown in FIG. 22(1). Specifically, in the rebalancing path table 113, three paths from the node n1, the node n2, and the backup storage apparatus b1 are registered for the volume v1, the paths from the node n1 and the node n4 are registered for the volume v2, and the paths from the node n1, the node n4, and the backup storage apparatus b1 are registered for the volume v5.

Next, in step S64, when the configuration considers data locality, and the volume v2 is a data locality target volume, the entry of the path of the volume v2 is deleted from the rebalancing path table 113 shown in FIG. 22(1) and thus the rebalancing path table 113 is in a state shown in FIG. 22(2).

When the rebalancing path table 113 is in the state shown in FIG. 22(2), and the rebalancing method is performance priority, one path (eb1, eb1) having the lowest path usage rate is selected as a path to be used from the rebalancing path table 113 for each of the volumes v1 and v5. As a result, the rebalancing path table 113 is updated to a state shown in FIG. 22(3) in step S69.

Further, when the rebalancing path table 113 is in the state shown in FIG. 22(2), and the rebalancing method is performance priority, a plurality of available paths (paths e1 and e2 for the volume v1 and paths e1 and e4 for the volume v5) are selected as paths to be used from the rebalancing path table 113 for the volumes v1 and v5. Although the path eb1 from the backup storage apparatus 400 is not selected as a path to be used in the present embodiment, it may be selected as a path to be used. As a result, the rebalancing path table 113 is updated to a state shown in FIG. 22(4) in step S69.

Further, when the rebalancing path table 113 is in the state shown in FIG. 22(2), and the rebalancing method is balancing, all paths (paths e1 and eb1 for the volume v1 and paths e1, e4, and eb1 for the volume v5) having path usage rates of equal to or smaller than a set threshold value (50% in this example) among available paths (paths e1, e2, and eb1 for the volume v1 and paths e1, e4, and eb1 for the volume v5) are selected as paths to be used from the rebalancing path table 113 for the volumes v1 and v5. As a result, the rebalancing path table 113 is updated to a state shown in FIG. 22(5) in step S69.

Next, the completion prediction time calculation process (step S20) will be described.

FIG. 23 is a flowchart of completion prediction time calculation process according to an embodiment.

The completion prediction time calculation unit 128 of the management system 100 determines whether the configuration of the rebalancing method is performance priority, speed priority, or balancing (step S71). Here, the configuration of the rebalancing method can be determined by the value of the rebalancing method 112c in the user configuration table 112.

If it is determined in step S71 that the rebalancing method is performance priority (step S71: priority on performance), the completion prediction time calculation unit 128 acquires each volume to be rebalanced (target volume) with reference to the rebalancing path table 113, acquires the sizes of target volumes with reference to the volume information table 115, identifies the remaining bandwidth of a path of each target volume with reference to the communication path information table 116, and divides the volume size of each target volume by each remaining bandwidth, to thereby calculate an estimated data copy time of each target volume (step S72).

If it is determined in step S71 that the rebalancing method is speed priority or balancing (step S71: performance priority or balancing), the completion prediction time calculation unit 128 acquires each volume to be rebalanced (target volume) with reference to the rebalancing path table 113, acquires the sizes of target volumes with reference to the volume information table 115, and identifies the remaining bandwidth of a path of each target volume with reference to the communication path information table 116. Next, when there are a plurality of paths for the same target volume, the completion prediction time calculation unit 128 divides the size of the target volume according to a remaining bandwidth ratio of each path. Next, if there are a plurality of paths for the same target volume, the completion prediction time calculation unit 128 calculates an estimated data copy time of the target volume by dividing a size allocated to each path by the remaining bandwidth of the paths, and if there are no multiple paths for the same target volume, calculates the estimated data copy time of the target volume by dividing the size of the target volume by the remaining bandwidth of the path (step S73).

Next, the completion prediction time calculation unit 128 calculates a completion prediction time of the entire rebalancing by adding estimated data copy times calculated for the respective target volumes (step S74). Next, the completion prediction time calculation unit 128 stores the calculated completion prediction time in the completion prediction time 120a of the rebalancing time management table 120, calculates a timeout time on the basis of the completion prediction time, and stores the calculated timeout time in the timeout time 120b of the rebalancing time management table 120 (step S75). The timeout time may be a predetermined time (for example, 1.5 times) the completion prediction time.

Next, node information notification process in each node 220 will be described.

FIG. 24 is a flowchart of node information notification process according to an embodiment.

The node information notification process is executed by each node 220 that has accepted a node information request from the management system 100.

The capacity monitoring unit 222 of the node 220 requests capacity information to a storage device 210 that is a management target (referred to as a target storage device) coupled to the node 220 (step S81) and receives the capacity information from the target storage device 210 (step S82). Here, the capacity information includes, for example, information indicating a maximum disk capacity, a disk usage rate, maximum disk I/O performance, a disk I/O usage rate, and the like of the target storage device 210.

Next, the I/O monitoring unit 224 requests I/O information and volume information to a computer 200 including the node 220 thereof (step S83) and acquires the I/O information and the volume information from the computer 200 (step S84). Here, the I/O information includes information on the communication path of the node 220 of the computer 200, for example, a path identifier, a node ID, a maximum communication path bandwidth, a communication path usage rate, and the like. Further, the volume information includes, for example, a volume ID, a volume identifier, a node ID, a volume size, and the like.

Next, the capacity notification unit 223 and the I/O notification unit 225 notify the manager 110 of the management system 100 of the capacity information received by the capacity monitoring unit 222 in step S82 and the I/O information and the volume information acquired by the I/O monitoring unit 224 in step S83 (step S85).

Next, rebalancing control process for controlling rebalancing process for transferring data of a rebalancing target volume to a transfer destination will be described.

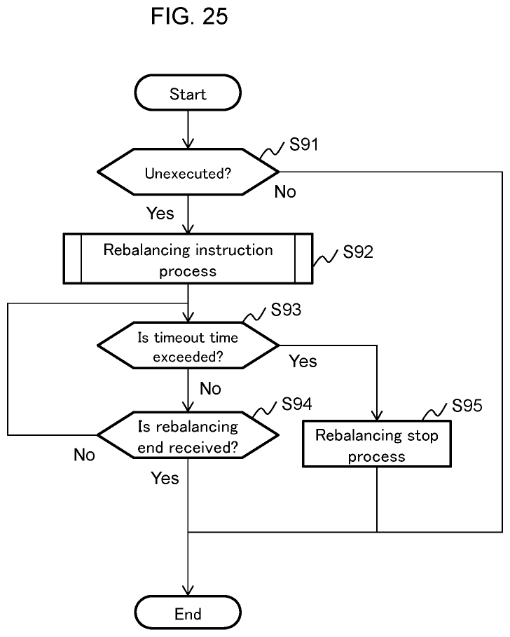

FIG. 25 is a flowchart of rebalancing control process according to an embodiment.

The rebalancing control process may be executed periodically, executed after the rebalancing preparation process has been performed, or executed at a predetermined time during which rebalancing process may be executed, for example. The rebalancing utilization resource calculation unit 127 determines whether or not there is unexecuted rebalancing process, that is, whether or not there is an entry for which an instructed time point has not been configured with reference to the rebalancing time management table 120 (step S91). As a result, if there is no unexecuted rebalancing process (NO in step S91), the rebalancing utilization resource calculation unit 127 ends the rebalancing control process.

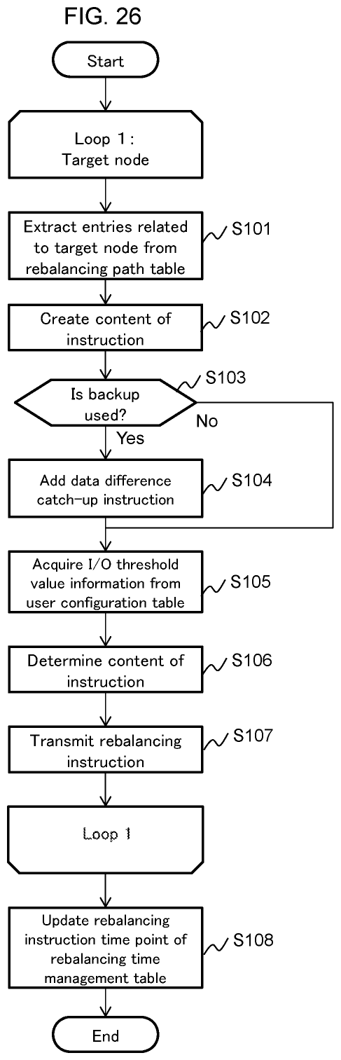

On the other hand, if there is unexecuted rebalancing process (Yes in step S91), the rebalancing utilization resource calculation unit 127 executes rebalancing instruction process (refer to FIG. 26) (step S92). According to the rebalancing instruction process, a rebalancing instruction for transmitting volumes to be rebalanced for nodes 220 involved in rebalancing to a transfer destination node 220 is transmitted, and the node 220 that has accepted the rebalancing instruction executes rebalancing process.

The rebalancing utilization resource calculation unit 127 determines whether or not a time since the start of the rebalancing process exceeds the timeout time (step S93). As a result, if the time does not exceed the timeout time (step S93: No), the rebalancing utilization resource calculation unit 127 determines whether or not rebalancing end has been received from the node 220 (step S94).

As a result, if the rebalancing end is not received from the node 220 (No in step S94), the rebalancing utilization resource calculation unit 127 proceeds with the process to step S93, and if the rebalancing end is received from the node 220 (Yes in step S94), the rebalancing utilization resource calculation unit 127 ends the rebalancing control process. After receiving the rebalancing end, volumes that have been transferred may be deleted from rebalancing target nodes.

On the other hand, if the time since the start of the rebalancing process exceeds the timeout time (Yes in step S93), this means that it is desirable to stop the rebalancing process, and thus rebalancing utilization resource calculation unit 127 executes process for stopping the rebalancing process (rebalancing stop process) (step S95) and ends the rebalancing control process. As a result, it is possible to appropriately prevent the rebalancing process from being continuously executed beyond the timeout time. Volumes that have been transferred by the time the rebalancing process ends may be deleted from the rebalancing target nodes.

Next, the rebalancing instruction process (step S92) will be described.

FIG. 26 is a flowchart of rebalancing instruction process according to an embodiment.

The rebalancing instruction unit 126 executes process of loop 1 (steps 5101 to 5107) with one of nodes that are transmission sources of volumes registered in the rebalancing path table 113 as a process target. Here, the node that is a process target in processing of loop 1 is referred to as a target node.

The rebalancing instruction unit 126 extracts all entries related to the target node from the rebalancing path table 113 (step S101).

Next, the rebalancing instruction unit 126 creates the content of an instruction for transmitting a volume corresponding to each entry to a transfer destination (step S102). Here, in case of rebalancing the same volume through a plurality of paths, the content of an instruction for transferring different ranges of the same volume in parallel for each path is created.

Next, the rebalancing instruction unit 126 determines whether or not the content of the instruction includes content regarding use of backup data (step S103).

As a result, if the content of the instruction does not include the content regarding use of backup data (NO in step S103), the rebalancing instruction unit 126 proceeds with the process to step S105, and, if the content of the instruction includes the content regarding use of backup data (YES in step S103), the rebalancing instruction unit 126 includes an instruction for resolving a difference from the current data for the backup data (difference catch-up instruction: for example, data difference cross-section information of backup data) in the content of the instruction (step S104), and process proceeds to step S105.

In step S105, the rebalancing instruction unit 126 acquires the threshold value (I/O threshold value information) of the rebalancing method threshold value 112d from the user configuration table 112 (step S105) and determines the content of a final instruction to the target node (step S106). Specifically, when the rebalancing method is balancing, the rebalancing instruction unit 126 determines the content of an instruction including the I/O threshold value information acquired in step S105. Here, if the content of the instruction includes the I/O threshold value information, the I/O control unit 226 of the node 220 controls communication such that a path usage rate becomes equal to or smaller than the threshold value of the I/O threshold value information in data transfer of volumes of the content of the instruction of rebalancing. Therefore, it is possible to perform rebalancing while curbing the load on paths.

Next, the rebalancing instruction unit 126 transmits a rebalancing instruction for executing rebalancing of the determined content of the instruction to the target node 220 (step S107) and ends process of the loop 1 for the target node.

When the rebalancing instruction unit 126 ends processing of loop 1 for the target node, the rebalancing instruction unit 126 executes process of loop 1 with another node for which process of loop 1 has not been executed as a new target node, executes process of loop 1 for all the nodes included in the rebalancing path table 113, stores the time point when the rebalancing instruction is given (rebalancing instruction time point) in the rebalancing instruction time point 120c of the rebalancing time management table 120 (step S108), and ends the rebalancing instruction process.

The present invention is not limited to the above-described embodiments and can be appropriately modified and implemented without departing from the spirit of the present invention.

For example, although the computer system 1 includes the backup system 300 and the backup storage apparatus 400 in the above embodiments, the backup system 300 and the backup storage apparatus 400 may not be included.

For example, although the storage device controlled by the node 220 is the storage device 210 in the computer 200 in the above embodiments, the present invention is not limited thereto, and the storage device may be an external storage device coupled to the computer 200.

Further, although any of performance priority, speed priority, and balancing can be selected and configured as a configuration of rebalancing process in the above embodiments, the present invention is not limited thereto, and rebalancing processing may be configured to performance priority, speed performance, or balancing in a fixed manner.

What is claimed is:

1. A management system for managing data rebalancing in a storage system that has a plurality of nodes configured to control input and output of data for a storage device that is a control target, and redundantly stores and manages predetermined data units in a plurality of storage devices, the management system comprising a processor unit,
wherein the processor unit is configured:
to acquire load information about paths for transmitting data of the plurality of nodes;
to determine, as a transmission source of a predetermined rebalancing target data unit, all nodes for which loads of the paths for transmitting the data of the nodes are equal to or smaller than a predetermined threshold value among a plurality of nodes controlling a storage device storing the rebalancing target data unit as a control target; and
to transmit different parts of the rebalancing target data unit in parallel from the plurality of nodes to a predetermined transfer destination node when a plurality of nodes are determined as the transmission source of the predetermined rebalancing target data unit.

2. The management system according to claim 1, wherein the management system includes a memory unit,
wherein the memory unit is configured to store arrangement designation information for designating an arrangement designation data unit which is a data unit that should be arranged in a storage device controlled by the nodes, and
the processor unit is configured to exclude the arrangement designation data unit from the rebalancing target data unit.

3. The management system according to claim 1, wherein data of a data unit at a predetermined time point is stored in a predetermined backup apparatus with respect to data units stored in the storage system, and
the processor unit is configured
to acquire backup information representing the data units stored in the backup apparatus,
when data of a predetermined rebalancing target data unit at a predetermined time point is stored in the backup apparatus, to determine, as a transmission source of the predetermined rebalancing target data unit, all ones for which loads of paths for transmitting data are equal to or smaller than a predetermined threshold value among the plurality of nodes and the backup apparatus on the basis of the loads of the paths for transmitting data of the nodes and a load of a path for transmitting data of the backup apparatus, and
to read the data of the data unit from the backup apparatus, to store the read data in the storage device controlled by the transfer destination node, and to reflect a change difference of the data unit from the predetermined time point in the stored data when the backup apparatus is determined as the transmission source.

4. The management system according to claim 1, wherein the processor unit is configured to end transmission of data with respect to one or more predetermined rebalancing target data units when a process time after transmission of the data with respect to the one or more predetermined rebalancing target data units is started has exceeded a predetermined timeout time.

5. The management system according to claim 4, wherein the processor unit is configured to estimate a completion prediction time until transmission of the one or more predetermined rebalancing target data units to the transfer destination node is completed after transmission of the data with respect to the one or more predetermined rebalancing target data units is started, and
to determine the timeout time on the basis of the completion prediction time.

6. The management system according to claim 1, wherein the processor unit is configured to estimate a completion prediction time until transmission of the one or more predetermined rebalancing target data units to the transfer destination node is completed after transmission of the data with respect to the one or more predetermined rebalancing target data units is started, and
to display and output the estimated completion prediction time.

7. The management system according to claim 1, wherein the processor unit is configured to transmit an instruction for controlling the plurality of determined nodes such that loads on the paths for transmitting the data of the plurality of nodes become equal to or smaller than a predetermined load.

8. The management system according to claim 1, wherein the processor unit is configured to acquire storage device load information about storage devices controlled by the plurality of nodes, and
to determine, as the predetermined rebalancing target data unit, at least one of data units that are stored by a node with a highest load of the storage devices and are not stored by a node with a lowest load of the storage devices on the basis of the storage device load information.

9. The management system according to claim 1, wherein the processor unit is configured, for transmission of a rebalancing target data unit, to accept any of a first configuration that emphasizes performance maintenance of each storage node, a second configuration that emphasizes transfer processing efficiency of the data unit, and a third configuration that improves transfer processing efficiency of the data unit in a state in which performance deterioration of the storage nodes is within an allowable range,
to determine, as a transmission source of a predetermined rebalancing target data unit, one of the plurality of nodes on the basis of the load information when the first configuration is accepted,
to determine, as a transmission source of a predetermined rebalancing target data unit, a plurality of nodes among a plurality of nodes coupled to a storage device storing the rebalancing target data unit when the second configuration is accepted,
to determine, as a transmission source of a predetermined rebalancing target data unit, all nodes for which loads of paths for transmitting the data of the nodes are equal to or smaller than a predetermined threshold value among a plurality of nodes having the storage device storing the rebalancing target data unit as a control target when the third configuration is accepted, and
to transmit the rebalancing target data unit from the determined node to a predetermined transfer destination node.

10. A data rebalancing management method performed by a management system for managing data rebalancing in a storage system that has a plurality of nodes for controlling input and output of data for a storage device that is a control target, and redundantly stores and manages predetermined data units in a plurality of storage devices, the method comprising:
acquiring load information about paths for transmitting data of the plurality of nodes;
determining, as a transmission source of a predetermined rebalancing target data unit, all nodes for which loads of the paths for transmitting the data of the nodes are equal to or smaller than a predetermined threshold value among a plurality of nodes controlling a storage device storing the rebalancing target data unit as a control target; and
transmitting different parts of the rebalancing target data unit in parallel from the plurality of nodes to a predetermined transfer destination node when a plurality of nodes are determined as the transmission source of the predetermined rebalancing target data unit.

11. A non-transitory computer-readable recording medium recording a data rebalancing management program executed by a computer for managing data rebalancing in a storage system that has a plurality of nodes configured to control input and output of data for a storage device that is a control target, and redundantly stores and manages predetermined data units in a plurality of storage devices, the data rebalancing management program causing the computer:
to acquire load information about paths for transmitting data of the plurality of nodes;
to determine, as a transmission source of a predetermined rebalancing target data unit, all nodes for which loads of the paths for transmitting the data of the nodes are equal to or smaller than a predetermined threshold value among a plurality of nodes controlling a storage device storing the rebalancing target data unit as a control target; and
to transmit different parts of the rebalancing target data unit in parallel from the plurality of nodes to a predetermined transfer destination node when a plurality of nodes are determined as the transmission source of the predetermined rebalancing target data unit.
